(19) United States
(12) Patent Application Publication
(10) Pub. No.: US 2024/0138614 A1
(43) Pub. Date: May 2, 2024

(54) LOCKING MECHANISM AND METHOD FOR CONTROLLING FOOD PROCESSOR

(71) Applicant: Panasonic Appliances Microwave Oven (Shanghai) Co., Ltd., SHANGHAI (CN)

(72) Inventor: Jieming Ding, SHANGHAI (CN)

(21) Appl. No.: 18/307,366

(22) Filed: Apr. 26, 2023

(30) Foreign Application Priority Data
Oct. 31, 2022 (CN) 202211350629.X

(51) Int. Cl. A47J 36/10; A47J 36/32; H05B 6/64

(52) U.S. Cl. CPC A47J 36/10; A47J 36/32; H05B 6/6414; A47J 27/04

(57) ABSTRACT

A locking mechanism and a food processor. The locking mechanism includes a panel; a lever mounting portion, disposed on the back side of the panel and having positioning holes; a lever, disposed on the back side of the panel and having pin shafts pivotally connected to the positioning holes; and an electromagnetic switch, disposed on the back side of the panel and capable of being in a locked state or an unlocked state with respect to the lever, wherein the electromagnetic switch has a push rod capable of expanding and retracting in the vertical direction, and the lever is provided with an opening portion into which the push rod can be inserted. The locking mechanism and the food processor can effectively prevent the situation that a child opens a door body and gets scalded, improving safety, and a child lock can also be easily eliminated, thus ensuring convenience.

### TECHNICAL FIELD

The present disclosure relates to the field of household appliances, and particularly relates to a locking mechanism and a method for controlling a food processor.

### BACKGROUND ART

Household appliances improve people's quality of life, but some of them may be dangerous for children. For example, a food processor is usually placed on a table and a door opening key is on the lowermost side of the food processor, which means that a child can easily open the door body of the food processor and comes into contact with heated food, and there is a risk that the child is scalded by the heated food. In order to prevent the situation that a child takes too hot food which could cause scalding, a locking mechanism with a child lock function is installed on these electric appliances. The child lock function in the prior art tends to prevent a child from operating the food processor at random, and in order to ensure that the child cannot open the door body to avoid scald, the door body is locked.

However, the locking mechanism is generally complex in structure and affects other components in the food processor, resulting in a complex or large-scale structure as a whole. How to achieve reliable locking and a concise structure at the same time has become an issue.

### SUMMARY

An exemplary aspect of the present disclosure provides a locking mechanism, including: a panel; a lever mounting portion, disposed on the back side of the panel and having positioning holes; a lever, disposed on the back side of the panel and having pin shafts pivotally connected to the positioning holes; and an electromagnetic switch, disposed on the back side of the panel and capable of being in a locked state or an unlocked state with respect to the lever; the electromagnetic switch having a push rod capable of expanding and retracting in the vertical direction, and the lever being provided with an opening portion into which the push rod can be inserted.

According to the above-mentioned technical solution, the lever mounting portion is fixedly mounted on the back side of the panel, and the pin shaft is pivotally connected to the positioning hole, so that the lever can do a fixed shaft rotation with respect to the lever mounting portion. When the locking mechanism is in the unlocked state, the push rod does not obstruct the rotation of the lever, and other components can be driven to act to open a door body by the rotation of the lever. When the push rod is inserted into the opening portion when the locking mechanism is in the locked state, the lever is obstructed by the push rod and cannot perform a further action, so that the door body cannot be opened. Therefore, the lever, the lever mounting portion and the electromagnetic switch are disposed on the back side of the panel so that the lever, the lever mounting portion and the electromagnetic switch are compactly arranged and can be matched with each other to achieve reliable locking. In addition, the push rod disposed in the vertical direction is matched with the opening portion to reliably obstruct the pressing force transmitted in the horizontal direction, and by vertically disposing the push rod, mounting is easy without performing an unnecessary perforation process on the side face of the panel.

In an exemplary embodiment, the lever mounting portion is integrally formed with the panel.

According to the above-mentioned technical solution, the lever mounting portion being integrally formed with the panel can reduce the number of parts and assembling steps, thereby facilitating the reduction of producing and manufacturing costs.

In an exemplary embodiment, the push rod is inserted into the opening portion when in the locked state; the push rod is moved away from the opening portion when in the unlocked state.

According to the above-mentioned technical solution, when powered on, the electromagnetic switch becomes magnetic under the action of a current, and the push rod is controlled to be inserted into the opening portion; when powered off, the electromagnetic switch becomes nonmagnetic, and the push rod is retracted to the electromagnetic switch, so that the locking mechanism is in the locked/unlocked state.

In an exemplary embodiment, the opening portion is disposed on the lower portion of the lever, and the pin shaft is disposed on the upper portion of the lever.

According to the above-mentioned technical solution, the opening portion is disposed on the lower portion of the lever so that the push rod can be inserted into the opening portion after stretching out in the vertical direction, whereby the lower portion of the lever is limited. The pin shaft is disposed on the upper portion of the lever, the lever should do a fixed shaft rotation around the pin shaft, since the opening portion on the lower portion of the lever is limited by the push rod, the lever cannot continue to rotate, and thus cannot drive other components to open the door body.

In an exemplary embodiment, the panel includes a front panel and a rear panel, the rear panel is provided with through holes, and the lever further has protruding portions capable of penetrating into the through holes.

According to the above-mentioned technical solution, the protruding portion passes through the through hole for transmitting torque, and when a pressure acts on the protruding portion, the protruding portion is pressed down, thereby driving the lever to do the fixed shaft rotation. The protruding portion penetrates into the through hole, reducing the space required for the locking mechanism, making the electromagnetic switch fit closer to the lever, and facilitating improving the space utilization rate of the locking mechanism.

Another exemplary aspect of the present disclosure a method for controlling a food processor, the food processor being provided with the above-mentioned locking mechanism, the control method including:
step S1: acquiring data relating to a processed material in the food processor;
step S2: calculating a curve of temperature variation of the processed material on the basis of the data; and
step S3: when the temperature of the processed material calculated in step S2 is lower than a predetermined threshold value, sending a control instruction so that a push rod of an electromagnetic switch in the locking mechanism is moved away from an opening portion of a lever.

According to the above-mentioned technical solution, the data relating to the processed material is acquired in step S1, so that the specific category of the processed material can be determined, and it is convenient to calculate the curve of temperature variation of the processed material in step S2. Since the curve of temperature variation is different for different categories of processed materials, it is necessary to calculate the curve of temperature variation of the processed material in step S2. When the temperature of the processed material falls below the predetermined threshold value, the temperature of the processed material at this moment does not cause scald to a person, so that the locking mechanism can enter an unlocked state. By the control method, while ensuring the safety, convenience in use is effectively improved for a user by achieving the unlocking of the locking mechanism in a more automated and intelligent way.

In an exemplary embodiment, acquiring data relating to a processed material in the food processor in step S1 includes acquiring weight data and/or heating time data of the processed material.

According to the above-mentioned technical solution, after determining the category of the processed material, the temperature variation of the processed material can be more accurately analyzed and judged in combination with the weight data and/or the heating time data of the processed material, so that the analyzed and calculated temperature variation coincides with actual temperature variation, and it is ensured that the temperature of the processed material will not cause scald to the user when the locking mechanism enters the unlocked state.

In an exemplary embodiment, the data relating to the processed material in the food processor acquired in step S1 includes power level data or power data, and preset time t1 varies in response to the heating time data, the power level data or the power data.

In an exemplary embodiment, step S2 includes step S21: calculating the curve of temperature variation of the processed material according to the category of the processed material and in combination with the weight data and/or the heating time data; and step S22: calculating the preset time t1 required for the temperature of the processed material to reach the threshold value, comparing the preset time t1 with standing time t2 of the heated processed material in the food processor, and judging whether the temperature of the processed material is lower than the threshold value.

According to the above-mentioned technical solution, the curve of temperature variation of the processed material is calculated according to the relevant data such as the category of the processed material, and the temperature variation of the processed material can be judged according to the curve of temperature variation, so that when the temperature of the processed material will drop to a temperature safe for the human body can be accurately calculated.

In an exemplary embodiment, the threshold value in step S3 ranges from 40° C. to 50° C.

According to the above-mentioned technical solution, in step S3, the threshold value is 50° C., so that the locking mechanism is opened only when the temperature of the processed material is lower than 50° C., and the user is prevented from being scalded under a high temperature of 50° C. or higher when contacting the processed material.

In an exemplary embodiment, the locking mechanism includes a display screen having a locking identifier, and sending a control instruction in step S3 also includes enabling the display state of the locking identifier to change.

According to the above-mentioned technical solution, when the locking mechanism changes from a locked state to the unlocked state or from the unlocked state to the locked state, the display state of the locking identifier changes, and the user can accurately and clearly know the locked/unlocked state of the locking mechanism at this moment according to the change of the display state of the locking identifier.

Another exemplary aspect of the present disclosure provides a method for controlling a food processor, including:

step S1: acquiring the heating action setting condition of a processed material in the food processor; and step S2: adjusting time for unlocking on the basis of the heating action setting condition.

### DESCRIPTION OF THE DRAWINGS

FIG. 1 is a three-dimensional view of a locking mechanism according to the first embodiment of the present disclosure.

FIG. 2 is an exploded view of the locking mechanism according to the first embodiment of the present disclosure.

FIG. 3 is another exploded view of the locking mechanism according to the first embodiment of the present disclosure.

FIG. 4 is a three-dimensional view of a lever and an electromagnetic switch according to the first embodiment of the present disclosure.

FIG. 5 is another three-dimensional view of the lever and the electromagnetic switch according to the first embodiment of the present disclosure.

FIG. 6 is another three-dimensional view of the locking mechanism according to the first embodiment of the present disclosure.

FIG. 7 is a three-dimensional view of a locking mechanism according to the second embodiment of the present disclosure.

FIG. 8 is an exploded view of the locking mechanism according to the second embodiment of the present disclosure.

FIG. 9 is a front view of a food processor according to the third embodiment of the present disclosure.

FIG. 10 is a locking logic view of the food processor according to the third embodiment of the present disclosure.

FIG. 11 is a front view of a display screen according to the third embodiment of the present disclosure.

FIG. 12 is a flow chart of a method for controlling the food processor according to the third embodiment of the present disclosure.

FIG. 13 is a flow chart of step S2 according to the third embodiment of the present disclosure.

FIG. 14 is a view of a curve of temperature variation of water according to the third embodiment of the present disclosure.

List of Reference Numerals: 100: locking mechanism; 200: food processor; 1: panel; 11: through hole; 12: front panel; 13: rear panel; 131: notch portion; 2: lever mounting portion; 21: positioning hole; 3: lever; 31: pin shaft; 32: opening portion; 33: protruding portion; 34: force bearing portion; 4: electromagnetic switch; 41: push rod; 5: door opening component; 6: door hook; 7: door opening key; 71: door opening guide post; 8: control key; 9: door body; 101: circuit board; 102: display screen; 103: locking identifier; P: vertical direction.

### DETAILED DESCRIPTION

The technical solutions in embodiments of the present disclosure will be clearly and completely described below with reference to the accompanying drawings in the embodiments of the present disclosure. Apparently, the described embodiments are merely some rather than all of the embodiments of the present disclosure. All other embodiments obtained by a person of ordinary skill in the art based on the embodiments in the present disclosure without creative efforts shall fall within the protection scope of the present disclosure.

### First Embodiment

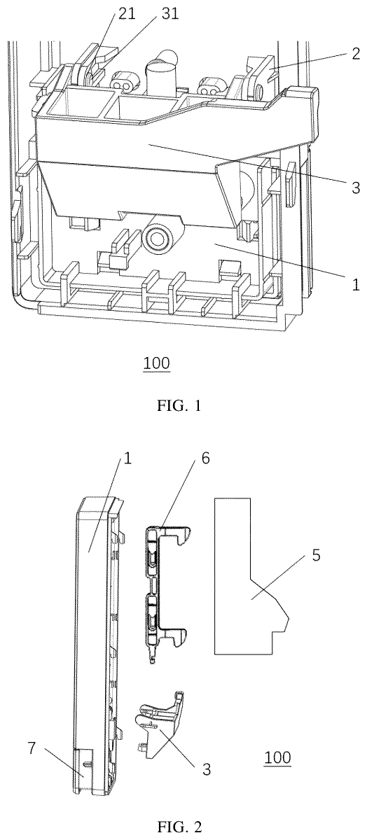

The present disclosure provides a locking mechanism 100, and FIG. 1 is a three-dimensional view of the locking mechanism 100 according to the first embodiment of the present disclosure. As shown in FIG. 1, the locking mechanism 100 includes a panel 1 and a lever mounting portion 2 disposed on the back side of the panel 1, the lever mounting portion 2 forming positioning holes 21. In the present embodiment, the lever mounting portion 2 is integrally formed with the panel 1, which makes connection of the lever mounting portion 2 and the panel 1 stable, and also can reduce the number of parts and assembling steps, thereby facilitating the reduction of producing and manufacturing costs. The locking mechanism 100 further includes a lever 3, the lever 3 has pin shafts 31 matching with the positioning holes 21, and the pin shaft 31 is pivotally connected to the positioning hole 21 so that the lever 3 can do a fixed shaft rotation around the pin shaft 31.

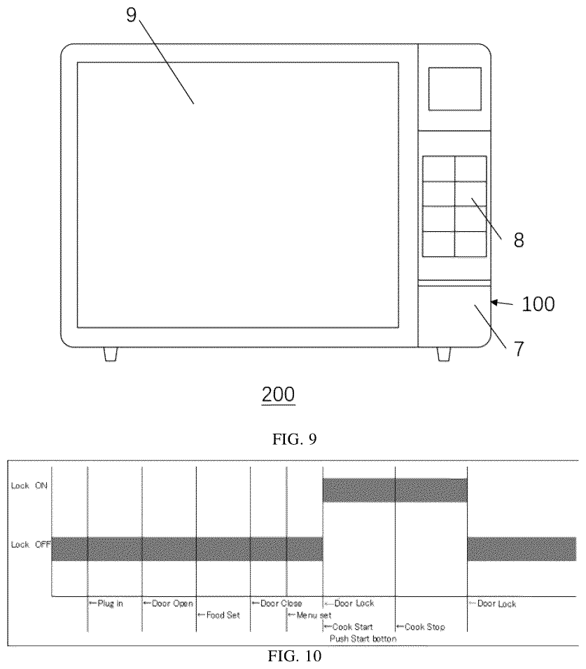

FIG. 2 is an exploded view of the locking mechanism 100 according to the first embodiment of the present disclosure. As shown in FIG. 2, the locking mechanism 100 is in linkage with a door opening component 5 and a door hook 6 engaged with the door opening component 5, the door opening component 5 being used for opening a door body 9 (shown in FIG. 9). The lever 3 rotates around the pin shaft 31 after receiving the pressure transmitted from a door opening key 7, and when the lever 3 rotates to a certain angle, the door opening component 5 is triggered, so that the door hook 6 which is engaged with the door opening component 5 is disengaged from the door opening component 5, thereby completing a door opening action. Here, the door opening component 5 and the door hook 6 are merely exemplary components, and the structures thereof are not particularly limited as long as the door opening component and the door hook can be in linkage with the locking mechanism 100 to complete the door opening action.

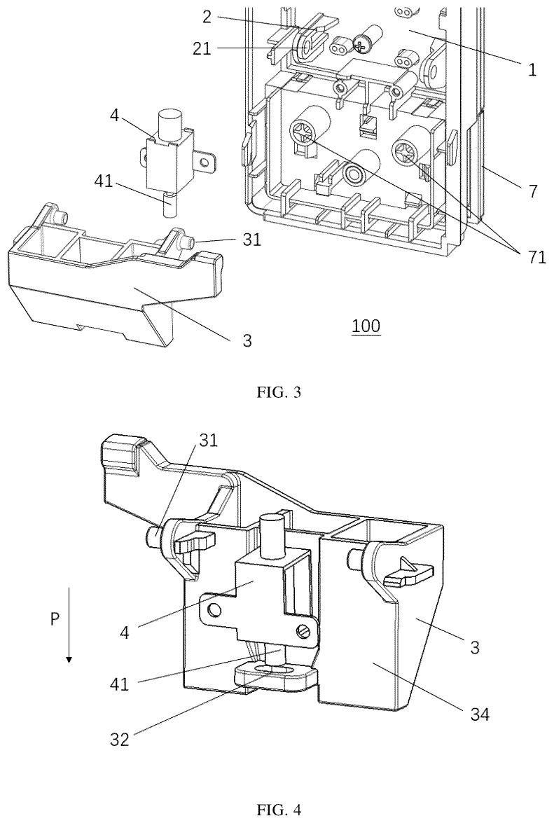

FIG. 3 is another exploded view of the locking mechanism 100 according to the first embodiment of the present disclosure. As shown in FIG. 3, the locking mechanism 100 further includes door opening guide posts 71, the door opening guide post 71 being in transmission connection with the door opening key 7, and after a user presses the door opening key 7, the door opening guide post 71 moves to the side close to the lever 3 and makes contact with a force bearing portion 34 (shown in FIG. 4) of the lever 3. In the present embodiment, there are two door opening guide posts 71, so that the door opening guide posts 71 apply a more uniform force to the door opening key 7, preventing the situation that because the force borne is uneven, the lever 3 is biased.

Further, an electromagnetic switch 4 is further disposed on the back side of the panel 1, and the “back side” refers to the side of the panel 1 opposite to the side where the door opening key 7 is located. The electromagnetic switch 4 is fixed to the panel 1 in a mode of a threaded connection, and due to the mode of a threaded connection, connection is stable and firm, and disassembling and assembling are facilitated. When the electromagnetic switch 4 is damaged, disassembling and assembling and replacing are facilitated, which is beneficial to reduce the maintenance cost.

FIG. 4 is a three-dimensional view of the lever 3 and the electromagnetic switch 4 according to the first embodiment of the present disclosure. As shown in FIG. 4, specifically, the lever 3 is provided with an opening portion 32 into which a push rod 41 can be inserted, and the electromagnetic switch 4 has the push rod 41 that can extend and retract in the vertical direction P. The electromagnetic switch 4 has an advantage of easy control, and when powered on, the electromagnetic switch 4 becomes magnetic under the action of a current to control the push rod 41 to be inserted into the opening portion 32. When powered off, the electromagnetic switch 4 becomes nonmagnetic, and the push rod 41 is retracted to the electromagnetic switch 4 under the action of a reset component (not shown), thereby returning to an unlocked state. The push rod 41 of the electromagnetic switch 4 in FIG. 4 is not extended, the push rod 41 is moved away from the opening portion 32, and the electromagnetic switch 4 is in the unlocked state with respect to the lever 3. When the locking mechanism 100 is in the unlocked state, the door opening action can be normally performed.

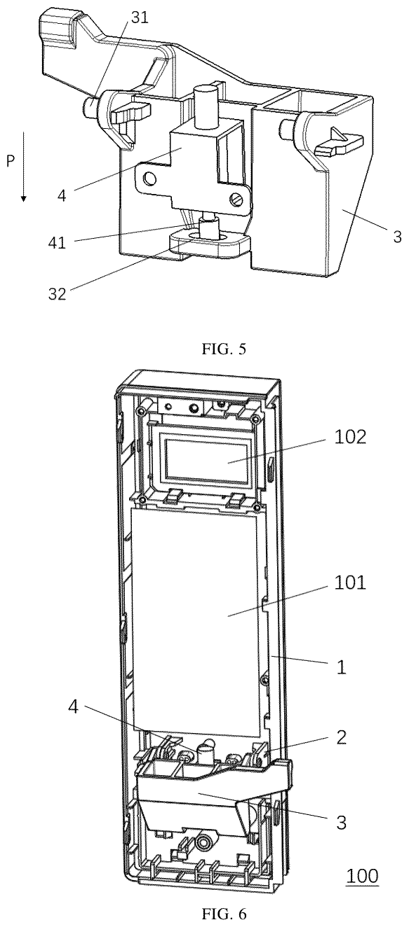

FIG. 5 is another three-dimensional view of the lever 3 and the electromagnetic switch 4 according to the first embodiment of the present disclosure. As shown in FIG. 5, when the electromagnetic switch 4 is in a locked state, the push rod 41 is inserted into the opening portion 32, and when the door opening key 7 is pressed, although the pressing force is transmitted to the lever 3, the portion of the push rod 41 in contact with the lever 3 provides a reaction force against the lever 3, so that the lever 3 cannot be pressed down. When the locking mechanism 100 is in the locked state, the lever 3 is prevented from moving under the control of the electromagnetic switch 4, so that the door opening component 5 (shown in FIG. 2) cannot be triggered by the lever 3.

Thus, the user controls the action of the electromagnetic switch 4 so that the locking mechanism 100 is in the locked/unlocked state, avoiding that a child can freely open the door body 9, and the user can also keep the locking mechanism 100 in the unlocked state for a long time according to actual needs, thereby enabling the locking mechanism 100 to improve convenience while ensuring safety.

In the present embodiment, the opening portion 32 is disposed on the lower portion of the lever 3 so that the push rod 41 can be extended into the opening portion 32 after stretching out in the vertical direction P. The pin shaft 31 is disposed on the upper portion of the lever 3, and since the opening portion 32 on the lower portion of the lever 3 is limited by the push rod 41, the lever 3 cannot continue to rotate around the pin shaft 31 on the upper portion even when the lever 3 is operated, and locking of the lever 3 is achieved with a simple structure, thereby achieving a good locking effect.

In the present embodiment, the push rod 41 is cylindrical, and the opening portion 32 is an oblong hole, so that the opening portion 32 remains a certain allowance, and the push rod 41 and the opening portion 32 achieve a clearance fit, so as to prevent the situation that since the push rod 41 and the opening portion 32 fit too tightly, it is difficult for the push rod 41 to extend and retract. In some other embodiments of the present disclosure, the shape of the push rod 41 and the opening portion 32 is not limited to a cylindrical shape or an oblong shape, and can also be other shapes, which is not specifically limited herein.

FIG. 6 is another three-dimensional view of the locking mechanism 100 according to the first embodiment of the present disclosure. As shown in FIG. 6, the back side of the panel 1 is further provided with a circuit board 101, and the circuit board 101 is electrically connected with the electromagnetic switch 4. The circuit board 101 is provided with a control portion (not shown), and the control portion can control the action of the electromagnetic switch 4 according to a user's instruction, or can automatically control the action of the electromagnetic switch 4 according to preset steps, so as to improve the automation level of the locking mechanism 100 and facilitate the user's use.

The locking mechanism 100 in the present embodiment has good versatility and also has high reliability on this basis, and can be applied to different types of household appliances and the like to improve safety.

### Second Embodiment

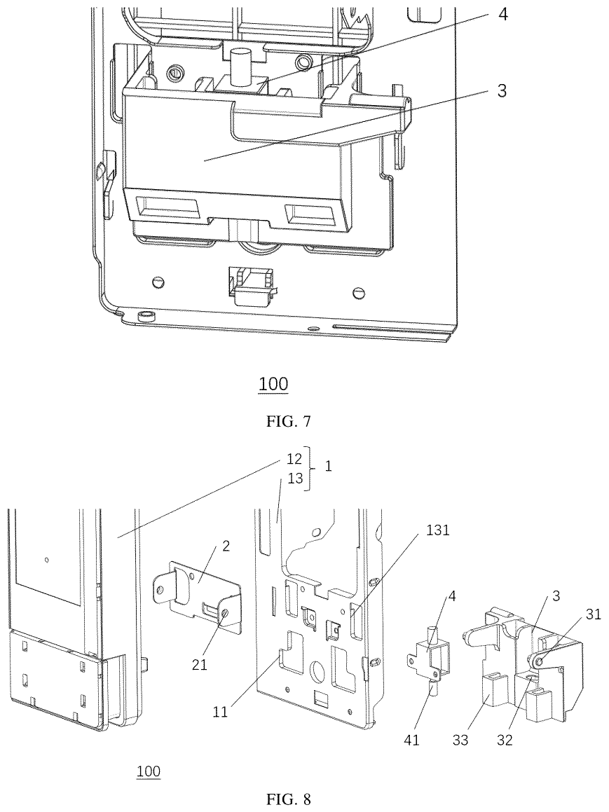

The present disclosure further provides a locking mechanism 100, FIG. 7 is a three-dimensional view of the locking mechanism 100 according to the second embodiment of the present disclosure, and FIG. 8 is an exploded view of the locking mechanism 100 according to the second embodiment of the present disclosure. As shown in FIG. 7 and FIG. 8, the locking mechanism 100 in the present embodiment differs from the locking mechanism 100 in the first embodiment in that, in the present embodiment, the lever mounting portion 2 and the lever 3 are different in mounting position and matching manner.

Further, the panel 1 includes a front panel 12 and a rear panel 13 disposed on the back side of the front panel 12, and the lever mounting portion 2 is disposed on the side of the rear panel 13 close to the front panel 12 and is threadedly connected to the rear panel 13. The main body part of the lever 3 is disposed on the back side of the rear panel 13, the pin shaft 31 passes through a notch portion 131 of the rear panel 13 and is pivotally connected to the positioning hole 21, and the lever 3 can do a fixed shaft rotation around the pin shaft 31, thereby triggering the door opening component 5 (shown in FIG. 2) to open the door body 9.

Further, the rear panel 13 is further provided with through holes 11, the lever 3 in the present embodiment has protruding portions 33 capable of penetrating into the through holes 11, and the protruding portion 33 matches with the through hole 11. The protruding portion 33 in the present embodiment functions similarly to the force bearing portion 34 in the first embodiment, and the protruding portion 33 is used for transmitting torque; when a pressure acts on the protruding portion 33, the protruding portion 33 is pressed down, and since the protruding portion 33 of the lever 3 is hinged to the lever mounting portion 2 via the pin shaft 31, the lever 3 does the fixed shaft rotation around the pin shaft 31, thereby triggering the door opening component 5. Also, the mode of embedded mounting reduces the space required for the locking mechanism 100 to allow the electromagnetic switch 4 to fit more tightly with the lever 3.

### Third Embodiment

The present disclosure further provides a method for controlling a food processor 200. FIG. 9 is a front view of the food processor 200 according to the third embodiment of the present disclosure. As shown in FIG. 9, the food processor 200 has the locking mechanism 100 according to the first embodiment or the second embodiment.

In the present embodiment, the locking mechanism 100 is mounted at a position corresponding to the door opening key 7, and a user can select whether to start the locking mechanism 100 or not according to his/her own needs when using the food processor 200.

Further, the food processor 200 is provided with control keys 8, and the locking mechanism 100 is triggered by pressing a single control key 8 or a combination of different control keys 8 such that the locking mechanism 100 is in a locked state or an unlocked state. The manner of triggering the locking mechanism 100 is not particularly limited, for example, a start key (START) for starting the food processing operation is included in the control keys 8, and when the user presses the start key, a non-illustrated control portion receives a corresponding signal and then controls the electromagnetic switch 4 via the circuit board 101 so that the locking mechanism 100 is in the locked state.

The food processor 200 is provided with the locking mechanism 100 described above, so that the door body 9 of the food processor 200 can be locked. When the push rod 41 is inserted into the opening portion 32, a child cannot open the door body 9, reducing the possibility that the child opens the food processor 200 and gets scalded. The user can also enables the push rod 41 to move away from the opening portion 32 so that the door body 9 can be freely opened, thereby improving convenience.

FIG. 10 is a locking logic view of the food processor 200 according to the third embodiment of the present disclosure. As shown in FIG. 10 and in conjunction with FIG. 9, from the time when the food processor 200 starts cooking to the time when the food processor stops cooking, the locking mechanism 100 remains the locked stated and the user cannot open the door body 9. When the food processor 200 does not perform cooking, the locking mechanism 100 remains the unlocked state, so that it is convenient for the user to perform operations such as opening and closing the door body 9, placing food, etc., thereby enabling the locking mechanism 100 and the food processor 200 to improve convenience while ensuring safety. As used herein, “cooking” refers broadly to processing food, including performing steam heating or microwave heating.

Further, the locking mechanism 100 includes a display screen 102 having a locking identifier 103, and the display state of the locking identifier 103 changes as the locked state/unlocked state of the locking mechanism 100 changes. FIG. 11 is a front view of the display screen 102 according to the first embodiment of the present disclosure, and as shown in FIG. 11, the display screen 102 is disposed on the front side of the panel 1 (shown in FIG. 6). As used herein, the front side refers to the side opposite to the back side. The display screen 102 is provided with the locking identifier 103, wherein the locking identifier 103 in the present embodiment is a key symbol; when the locking mechanism 100 is in the locked state, the key symbol remains normally on; when the lock mechanism 100 is in the unlocked state, the key symbol is flickering. The user can accurately and clearly know the locked/unlocked state of the locking mechanism 100 at this moment according to the normally on and flickering states of the key symbol.

In some other embodiments of the present disclosure, the locking identifier 103 is not limited to a key symbol, and may also take other forms, and the change state of the locking identifier 103 is not limited to normally on/flickering, either. For example, in some other embodiments of the present disclosure, the locking identifier 103 may also be a letter symbol, and the letter symbol is displayed as “LOCK” when the locking mechanism 100 is in the locked state; and the letter symbol is displayed as “OFF” when the locking mechanism 100 is in the unlocked state. The display screen 102 can facilitate observing and judging the locking state of the locking mechanism 100 by the user, thereby facilitating improving the user's use experience.

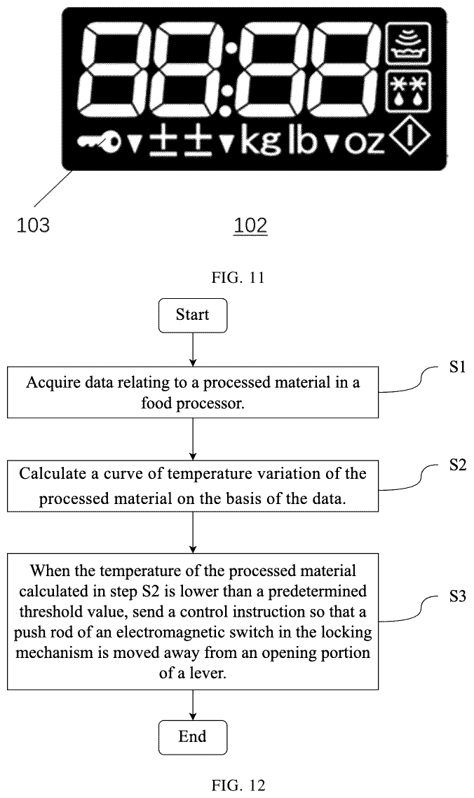

FIG. 12 is a flow chart of a method for controlling the food processor 200 according to the third embodiment of the present disclosure, and as shown in FIG. 12, the control method includes step S1, step S2, and step S3. First, step S1 is entered, in step S1, the control portion acquires data relating to a processed material in the food processor 200, the processed material herein may be vegetables, meat, milk, water, etc.

In the present embodiment, it is desirable to determine the category of the processed material. The data relating to the processed material may be acquired in a mode of user input in step S1. For example, the food processor 200 may be provided with mode keys for a plurality of categories of processed materials, and after the user presses the mode key corresponding to the processed material, the food processor 200 knows the category of the processed material and can perform heating in a heating manner suitable for the category. For example, the food processor 200 is provided with mode keys corresponding to “vegetables”, “meat”, “milk”, etc., and after the user puts water into the food processor 200, the user presses the mode key corresponding to “water” disposed on the food processor 200, and then, the food processor 200 processes the water in a heating manner suitable for the water. When the food processor 200 starts to perform heating, the control portion controls the electromagnetic switch 4 to insert the push rod 41 into the opening portion (shown in FIG. 3), so that the locking mechanism 100 is in the locked state, and the door body 9 (shown in FIG. 9) cannot be opened at this moment. After heating ends, the locking mechanism 100 still remains the locked state until step S3.

In addition, the user may directly set the heating time and/or the power level without setting the category of the processed material, and the control portion may perform setting processing according to the general processed material.

In some other embodiments of the present disclosure, the determination of the category of the processed material is not limited to the manner set by the user on his/her own, but may be dependent on other manners, which is not specifically limited herein.

In the present embodiment, acquiring data relating to a processed material also includes acquiring weight data and heating time data of the processed material. The weight data may be obtained by disposing a weight sensor in the food processor 200, the weight sensor being capable of detecting the weight data of a material to be processed and transmitting the detected weight data to the control portion. The heating time data may be determined according to the heating time corresponding to the mode key, or may be determined according to the heating time set by the user on his/her own.

In some other embodiments of the present disclosure, the mode for acquiring the weight data and the heating data is not limited to the modes described above, but may be other modes; in addition, the data relating to the processed material is not limited to the weight data or the heating time data, but may be other data, which is not specifically limited herein.

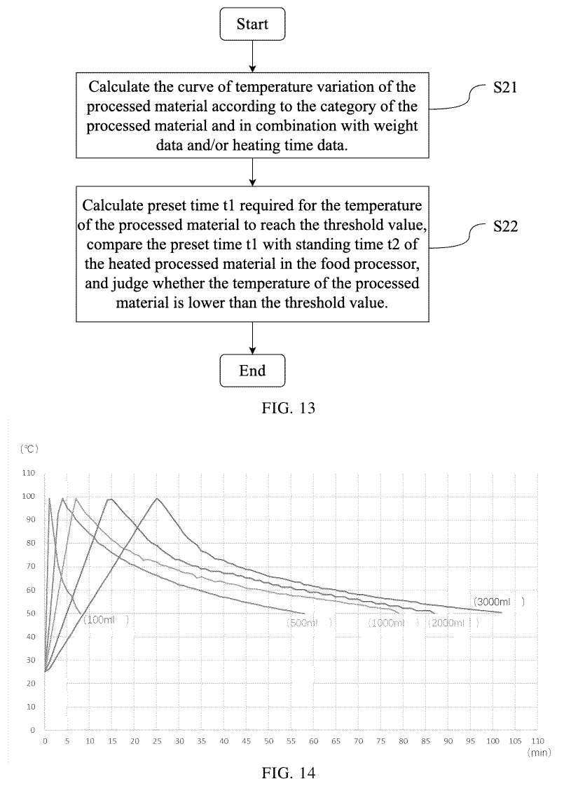

After step S1 is completed, step S2 is entered. FIG. 13 is a flow chart of step S2 according to the third embodiment of the present disclosure, and as shown in FIG. 13, in step S2, a curve of temperature variation of the processed material is calculated on the basis of the data. Specifically, step S2 includes step S21 and step S22.

In step S21, the curve of temperature variation of the processed material is calculated by the control portion according to the category of the processed material and in combination with the weight data and the heating time data.

For example, after the user presses the mode key corresponding to “water”, the food processor 200 performs a heat treatment on the processed material in a heating manner corresponding to water, and also performs calculation according to the curve of temperature variation of water. Since the data obtained in step S1 further includes the weight data of the processed material and the heating time data, the weight of the water at this moment and the initial temperature after heating can be known.

FIG. 14 is a view of a curve of temperature variation of water according to the third embodiment of the present disclosure, and as shown in FIG. 14, FIG. 14 includes temperature variation of water of different volumes (here, the volume represents the weight). After practical experiments, it is found that about 7 min is needed to lower the temperature of 100 mL (0.1 kg) of water from 100° C. to 50° C., while about 40 min is needed to lower the temperature of 500 mL (0.5 kg) of water from 100° C. to 50° C., and about 53 min is needed to lower the temperature of 1000 mL (1 kg) of water from 100° C. to 50° C. Several such points are collected through the practical experiments, a fitted curve of temperature variation as shown in FIG. 14 is formed according to these points, and the temperature variation can be accurately judged according to the curve.

In the present embodiment, the control portion presets the curve of temperature variation of different categories of processed materials and can distinguish the temperature variation of the different categories of processed materials in different weight states.

If the control portion does not preset the curve of temperature variation of the material to be processed of a certain weight, the curve of temperature variation is calculated according to closest weight data which is greater than the weight in preset weight data. For example, if the weight sensor detects that the material to be processed is 0.97 kg, and the preset curve of temperature variation includes curves of temperature variation of the processed material at 0.9 kg and 1 kg, then the material to be processed is analyzed and calculated according to the curve of temperature variation of 1 kg.

After step S21 is completed, step S22 is entered. In step S22, according to the curve of temperature variation of the processed material obtained in step S21, preset time t1 required for the temperature of the processed material to reach a threshold value is calculated, and the preset time t1 is set according to a setting criterion that a human body is not injured when the temperature of the processed material is lower than the threshold value, and the threshold value is preferably about 50° C.

The preset time t1 is compared with standing time t2 of the heated processed material in the food processor 200. If the standing time t2 is less than or equal to the preset time t1, then it is judged that the temperature of the processed material is not lower than the threshold value; if the standing time t2 is greater than the preset time t1, it is judged that the temperature of the processed material is lower than the threshold value, and step S3 is entered at this moment.

In step S3, since the predicted temperature of the processed material calculated in step S22 is lower than the predetermined threshold value, the temperature of the processed material at this moment does not cause injury to a person, and the control portion sends a control instruction to enable the push rod 41 of the electromagnetic switch 4 in the locking mechanism 100 to move away from the opening portion of the lever, so that the locking mechanism 100 enters the unlocked state. Thus, while ensuring the safety, convenience in use is effectively improved for the user by achieving the unlocking of the locking mechanism 100 in a more automated and intelligent way.

In the present embodiment, as described above, the threshold value in step S3 is preferably 50° C., and no scald is caused to the human body under 50° C., which is suitable for the use scenario. In some other embodiments of the present disclosure, the threshold value is not limited to 50° C., but may be other temperatures, such as a temperature in the ramp of 40° C. to 50° C. which is not specifically limited herein

TABLE 1

| | | | | Highest | Time required |
|---|---|---|---|---|---|
| | | Initial | | water | for the temper- |
| Power | Heating | temper- | Time for | temper- | ature to drop |
| level | power | ature | boiling water | ature | to 50° C. |
| P10 | 1250 W | 24.7 | 0:07:54 | 98.2 | 0:49:12 |
| P7 | 800 W | 24.2 | 0:20:04 | 99.1 | 0:44:56 |
| P4 | 400 W | 26.0 | Water is | 95.3 | 0:39:28 |
| | | | not boiled after | | |
| | | | two cycles of | | |
| | | | 60 min | | |
| | | 26.0 | Water is | 96.7 | 0:41:58 |
| | | | not boiled after | | |
| | | | three cycles of | | |
| | | | 90 min | | |
| P3 | 300 W | 25.4 | Water is | 82.4 | 0:36:08 |
| | | | not boiled after | | |
| | | | one cycle of 30 | | |
| | | | min | | |
| | | 25.1 | Water is | 87.0 | 0:38:54 |
| | | | not boiled after | | |
| | | | two cycles of | | |
| | | | 60 min | | |

In the present embodiment, the data obtained in step S1 further includes power level data or power data of the food processor.

In Table 1, the temperature variation of water under four heating powers is listed, and it should be noted that the processed material herein is 1 L of water. It can be seen that the greater the heating power, i.e., the power data, the easier it is to rise the water temperature and the longer time it takes to drop the temperature to 50° C.

For the same heating power, e.g., the heating power of 500 w, the water temperature is 87° C. after the heating time of two cycles of 60 min. After the heating time of one cycle of 30 min, the water temperature is 82.4° C. Lowering the temperature of the water after two cycles to 50° C. requires 38 min 54 s, while lowering the temperature of the water after one cycle to 50° C. requires 36 min 08 s. It can be seen that under the same condition, the longer the heating time, the longer time it takes to drop the temperature to 50° C.

Therefore, the preset time t1 required for the temperature of the processed material to drop to a temperature safe for the human body varies in response to the heating time data, the power level data, or the power data, thereby securing safety and avoiding scald of the person.

Further, the following formula can be used to perform calculation according to the relationship based on the time (unit: second) required to drop the temperature to 50° C.:

t=P*0.04+L*90+2000
wherein P is the heating power, e.g., 1250 w, 800 w, 400 w or 300 w. L is the power level, e.g., the levels of 10, 8, 4 and 3.

The time calculated from the formula is compared with the time in Table 1 below:
at the level of 10 and the power of 1250 w, t=1250×0.04+10×90+2000=50+900+2000=2950 (in Table 1, 2952);
at the level of 4 and the power of 400 w, t=400×0.04+4×90+2000=16+360+2000=2376 (in Table 1, 2518);
at the level of 3 and the power of 300 w, t=300×0.04+3×90+2000=12+270+2000=2282 (in Table 1, 2334).

It can be seen that the data calculated using the formula matches with the actual experimental data. By applying the formula to the calculation of the preset time t1, accurate results can be obtained quickly and easily. The formulae for water are listed above. The temperature variation of other types of materials to be processed can also be calculated according to the corresponding formulae and are not listed here.

### Fourth Embodiment

The present embodiment provides a method for controlling a food processor, applied to the food processor 200, the food processor 200 including a door opening key 7. The door body 9 of the food processor 200 can be opened by pressing the door opening key 7 by a user when the locking mechanism 100 is in an unlocked state; when the locking mechanism 100 is in a locked state, the user is unable to open the door body 9 even by pressing the door opening key 7. The same parts as in the third embodiment are not repeated.

In the present embodiment, the user can adjust time for unlocking (the time when the locking mechanism is controlled to be in the unlocked state) directly by setting a heating action setting condition.

More specifically, the control method includes: step S1: acquiring the heating action setting condition of a processed material in the food processor; and step S2: adjusting the time for unlocking on the basis of the heating action setting condition.

In the present embodiment, the heating action setting condition may be power data, and is adjusted in step S2 in such a way that the time for unlocking becomes longer as the power data increases. Furthermore, the heating action setting condition may also be the heating time, and is adjusted in step S2 in such a way that the time for unlocking becomes longer as the heating time becomes longer.

When the time for unlocking is up, the temperature of the material to be processed is considered to have dropped to, for example, below 50° C. At this moment, the control portion sends a control instruction to enable the push rod 41 of the electromagnetic switch 4 in the locking mechanism 100 to move away from the opening portion of the lever (shown in FIG. 3) and the locking mechanism 100 enters the unlocked state. Of course, depending on practical needs, during the safety time, it is also possible to unlock the food processor by using a combination of keys, so that the food can also be taken out in the safety period. Specifically, the keys include, for example, a “frequency converting defrosting” key, a “stop/reset” key and a “start” key, operation can be performed by pressing the “frequency converting defrosting” key, the “stop/reset” key and the “start” key in sequence within a predetermined time range to enable the locking mechanism 100 to be in the unlocked state.

Based on the data in Table 1 and by supplementing data relevant to the heating time, Table 2 below is listed.

| | | |
|---|---|---|
| Power data | Heating time | Time for unlocking |

| | | | |
|---|---|---|---|
| 1250 | w | 7 min54 s | 49 min12 s |
| 800 | w | 20 min4 s | 44 min56 s |
| 400 | w | 60 min | 39 min28 s |
| 400 | w | 90 min | 41 min58 s |
| 300 | w | 30 min | 36 min08 s |
| 300 | w | 60 min | 38 min54 s |

Table 2 Correspondence between the time for unlocking and the power data and the heating time

As mentioned above, in the present embodiment, there is no need to calculate the curve of temperature variation and the time for unlocking can be set directly based on the power data or the heating time data, which is efficient and ensures that a person is not scalded at the safety time t3, regardless of the category and weight of the processed material. The locking mechanism 100 is in the locked state when the user uses the food processor 200 to process the processed material, thus preventing the situation that a user or child accidentally opens the door body 9 and gets scalded. The locking mechanism 100 in the present embodiment can automatically enter the unlocked state from the locked state after processing ends, and the time required to enter the unlocked state after processing ends is the time for unlocking. When the time for unlocking is up, the temperature of the processed material in the food processor 200 is no longer likely to cause scald to the human body. Thus, the locking mechanism 100 which can be automatically unlocked when the time for unlocking is up improves convenience while also ensuring safety.

As can be seen from the data in Table 2, the higher the power data, the longer the time for unlocking. Under the same power data, the longer the heating time, the longer the time for unlocking.

It will be appreciated by those skilled in the art that specific technical features in the various embodiments may be adaptively split or combined. Such division or combination of specific technical features does not cause the technical solution to deviate from the principle of the present disclosure, and therefore the technical solution after division or combination falls within the scope of protection of the present disclosure. In the description of the present application, “a plurality of” means two or two or more, unless it is specifically defined otherwise.

The description provides only exemplary embodiments of the present disclosure and is not intended to limit the present disclosure. Any modification, equivalent replacement, or improvement made within the spirit and principle of the present disclosure shall fall within the protection scope of the present disclosure.

What is claimed is:

1. A locking mechanism, comprising:
a panel;
a lever mounting portion, disposed on the back side of the panel and having positioning holes;
a lever, disposed on the back side of the panel and having pin shafts pivotally connected to the positioning holes; and
an electromagnetic switch, disposed on the back side of the panel and capable of being in a locked state or an unlocked state with respect to the lever;
the electromagnetic switch having a push rod capable of expanding and retracting in the vertical direction, and the lever being provided with an opening portion into which the push rod is able to be inserted.

2. The locking mechanism according to claim 1, wherein the lever mounting portion is integrally formed with the panel.

3. The locking mechanism according to claim 2, wherein the push rod is inserted into the opening portion when in the locked state; the push rod is moved away from the opening portion when in the unlocked state.

4. The locking mechanism according to claim 1, wherein the opening portion is disposed on the lower portion of the lever, and the pin shaft is disposed on the upper portion of the lever.

5. The locking mechanism according to claim 1, wherein the panel comprises a front panel and a rear panel, the rear panel is provided with through holes, and the lever further has protruding portions capable of penetrating into the through holes.

6. A method for controlling a food processor, the food processor having the locking mechanism according to claim 1, comprising:
step S1: acquiring data relating to a processed material in the food processor;
step S2: calculating a curve of temperature variation of the processed material on the basis of the data; and
step S3: when the temperature of the processed material calculated in step S2 is lower than a predetermined threshold value, sending a control instruction so that a push rod of an electromagnetic switch in the locking mechanism is moved away from an opening portion of a lever.

7. The method for controlling a food processor according to claim 6, wherein acquiring data relating to a processed material in the food processor in step S1 comprises acquiring weight data and/or heating time data of the processed material.

8. The method for controlling a food processor according to claim 7, wherein step S2 comprises:
step S21: calculating the curve of temperature variation of the processed material according to the category of the processed material and in combination with the weight data and/or the heating time data; and
step S22: calculating preset time t1 required for the temperature of the processed material to reach the threshold value, comparing the preset time t1 with standing time t2 of the heated processed material in the food processor, and judging whether the temperature of the processed material is lower than the threshold value.

9. The method for controlling a food processor according to claim 8, wherein in the step S1: acquiring data relating to a processed material in the food processor, the data relating to the processed material in the food processor comprises power level data or power data, and the preset time t1 varies in response to the heating time data, the power level data or the power data.

10. The method for controlling a food processor according to claim 6, wherein the threshold value in step S3 ranges from 40° C. to 50° C.

11. The method for controlling a food processor according to claim 7, wherein the locking mechanism comprises a display screen having a locking identifier, and sending a control instruction in step S3 further comprises enabling the display state of the locking identifier to change.

12. A method for controlling a food processor, comprising:
step S1: acquiring a heating action setting condition of a processed material in the food processor; and
step S2: adjusting a time for unlocking the food processor on the basis of the heating action setting condition.

13. The method for controlling a food processor according to claim 12, wherein the heating action setting condition is power data, and adjusted in step S2 such that the time for unlocking becomes longer as the power data increases.

14. The method for controlling a food processor according to claim 12, wherein the heating action setting condition is heating time, and adjusted in step S2 such that the time for unlocking becomes longer as the heating time becomes longer.
